(19) United States
(12) Patent Application Publication
(10) Pub. No.: US 2016/0119880 A1
(43) Pub. Date: Apr. 28, 2016

(54) WIRELESS BEACON DEVICE

(71) Applicants: Hsuan-Chih HONG, Taipei City (TW); Yi WANG, Vancouver (CA)

(72) Inventors: Hsuan-Chih HONG, Taipei City (TW); Yi WANG, Vancouver (CA)

(21) Appl. No.: 14/525,116

(22) Filed: Oct. 27, 2014

(51) Int. Cl. H04W 52/02; H04W 4/00

(52) U.S. Cl. CPC H04W 52/0296; H04W 4/008; H04W 52/0251

(57) ABSTRACT

A wireless beacon device including an optoelectronic unit, a thermoelectric unit, a power source selector and a beacon unit is provided. The optoelectronic unit is adapted for generating a first voltage and the thermoelectric unit is adapted for generating a second voltage. The power source selector has a first input end adapted for receiving the first voltage and a second input end adapted for receiving the second voltage. The power source selector is adapted for outputting the first voltage or the second voltage based on a predetermined comparison relationship. The beacon unit electrically coupling to the power source selector is adapted for transmitting a wireless signal by means of the first voltage or the second voltage output by the power source selector.

### FIELD OF THE INVENTION

The present invention relates to a wireless beacon device which can transmit a signal and in particular, relates to a wireless beacon device with multiple power sources.

### DESCRIPTION OF THE PRIOR ART

Providing related information according to consumer preferences in order to achieve advertisement effects is always one of the important tasks carried out by service providers and retailers. Methods of analyzing consumer preferences and providing advertisements are persistently developed to effectively supply consumers with information that interests them.

In US patent publication no. 2002/0004753, a system of searching for specific product information and providing it to consumers is put forth. The system comprises a server which not only stores product-related information as well as URLs on the Internet related to the products but also stores additional information, such as promotions, discounts, concessions, and comments, posted on the websites of the URLs. The products are discernible by the universal product codes (UPCs). Moreover, a product manufacturer can create and maintain a UPC/URL database on the Internet, and the UPC/URL database is dedicated to the product manufacturer's product information.

In addition to the aforesaid method of providing information to consumers with a server through the Internet, the prior art includes a method of providing information to consumers through effectuating short-distance transmission of wireless signals with a wireless beacon device.

In US patent publication no. 2008/0056215, a wireless device, such as a cell phone, capable of comparing consumers' profiles with product data provided by a wireless beacon device is put forth, so as to supply consumers with product information which is likely to interest them. For example, as soon as consumers enter a shop equipped with a wireless beacon device, the consumers' cell phones receive product information which is broadcast by the wireless beacon device, and then compare the product information with the consumers' profiles. If a result of the comparison process indicates that the product information may interest the consumers, the product information will be displayed on the consumers' cell phones.

The wireless beacon devices can be arranged at many appropriate places in order to supply required information to consumers according to the consumers' locations. Hence, it is required to supply power to the wireless beacon device for a quite long time.

### SUMMARY OF THE INVENTION

It is an objective of the present invention to provide a wireless beacon device with multiple power sources such that the wireless beacon device can operate for a quite long time.

Another objective of the present invention is to provide a wireless beacon device which can be disposed at a light source and powered by optical energy or thermal energy generated by the light source.

The present invention provides a wireless beacon device comprising an optoelectronic unit, a thermoelectric unit, a first power source selector and a beacon unit. The optoelectronic unit is adapted for generating a first voltage. The thermoelectric unit is adapted for generating a second voltage. The first power source selector has a first input end and a second input end adapted for receiving the first voltage and the second voltage, respectively. The first power source selector is adapted for outputting the first voltage or the second voltage according to a first predetermined comparison relationship. The beacon unit is electrically connected to the first power source selector and adapted for transmitting a wireless signal by means of the first voltage or the second voltage output by the first power source selector.

In an embodiment of the present invention, the first predetermined comparison relationship comprises that the first power source selector outputs the second voltage if a voltage level of the second voltage is higher than a voltage threshold.

In an embodiment of the present invention, the first predetermined comparison relationship further comprises that the first power source selector outputs the first voltage if the voltage level of the second voltage is lower than the voltage threshold and a voltage level of the first voltage is higher than the voltage threshold.

In an embodiment of the present invention, the wireless beacon device further comprises a housing. The optoelectronic unit, the thermoelectric unit, the first power source selector and the beacon unit are disposed at the housing.

In an embodiment of the present invention, the housing is curved.

In an embodiment of the present invention, the optoelectronic unit and the thermoelectric unit are disposed at an external surface of the housing. When the wireless beacon device is disposed at a light source, the external surface faces a light-emitting surface of the light source.

In an embodiment of the present invention, the thermoelectric unit is disposed at a first external surface of the housing, and the optoelectronic unit is disposed at a second external surface of the housing. The second external surface is opposite to the first external surface. When the wireless beacon device is disposed at a light source, the first external surface faces a light-emitting surface of the light source.

In an embodiment of the present invention, the thermoelectric unit and a portion of the optoelectronic unit are disposed at a first external surface of the housing, and another portion of the optoelectronic unit is disposed at a second external surface of the housing. The second external surface is opposite to the first external surface. When the wireless beacon device is disposed at a light source, the first external surface faces a light-emitting surface of the light source.

In an embodiment of the present invention, the housing is C-shaped.

In an embodiment of the present invention, the wireless beacon device further comprises a voltage regulator, a battery charge controller, a rechargeable battery and a second power source selector. The voltage regulator is electrically connected to the first power source selector and adapted for adjusting the first voltage or the second voltage output by the first power source selector so as to output a working voltage. The battery charge controller is electrically connected to the voltage regulator and adapted for receiving the working voltage. The rechargeable battery electrically connected to the battery charge controller. The battery charge controller is adapted for detecting a battery voltage of the rechargeable battery so as to determine whether to charge the rechargeable battery with the working voltage. The second power source selector has a first input end and a second input end adapted for receiving the working voltage and the battery voltage, respectively. The second power source selector is adapted for outputting the working voltage or the battery voltage according to a second predetermined comparison relationship. The beacon unit is electrically connected to the second power source selector and adapted for receiving the working voltage or the battery voltage output by the second power source selector so as to transmit the wireless signal.

In an embodiment of the present invention, the second predetermined comparison relationship comprises that the second power source selector outputs the working voltage if a voltage level of the working voltage is higher than a voltage threshold.

In an embodiment of the present invention, the second predetermined comparison relationship further comprises that the second power source selector outputs the battery voltage if the voltage level of the working voltage is lower than the voltage threshold and a voltage level of the battery voltage is higher than the voltage threshold.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The following description, the appended claims, and the embodiments of the present invention further illustrate the features and advantages of the present invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a block diagram of a circuit of a wireless beacon device with multiple power sources according to a first embodiment of the present invention.

FIG. 2A is a schematic perspective view of the wireless beacon device of the first embodiment of the present invention which is not disposed at any light source.

FIG. 2B is a schematic perspective view of the wireless beacon device of the first embodiment of the present invention which is disposed at a light source.

FIG. 2C is a schematic perspective view of the wireless beacon device of the first embodiment of the present invention which is disposed at another light source.

FIG. 3 is a schematic end view of a light source where a wireless beacon device according to a second embodiment of the present invention is disposed.

FIG. 4 is a block diagram of a circuit of a wireless beacon device with multiple power sources according to a third embodiment of the present invention.

FIG. 5 is a schematic perspective view of a wireless beacon device according to a fourth embodiment of the present invention which is disposed at a light source.

### DETAILED DESCRIPTION OF THE EMBODIMENTS

### First Embodiment

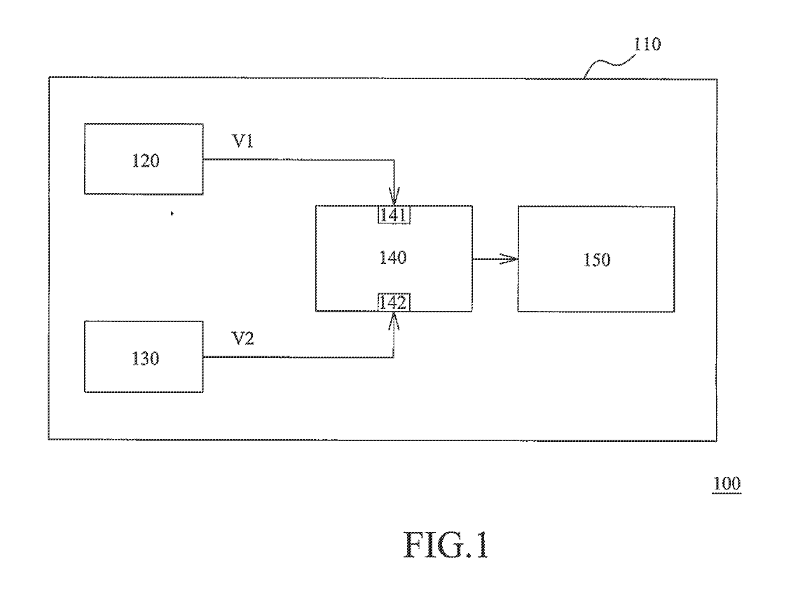

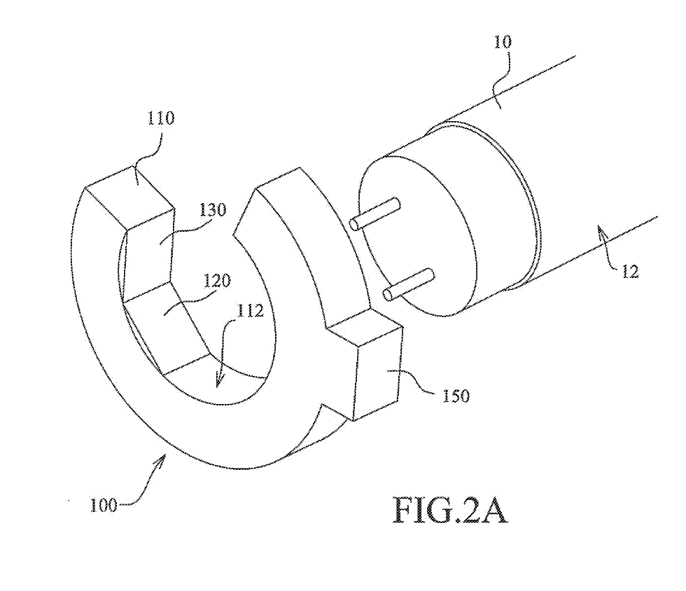

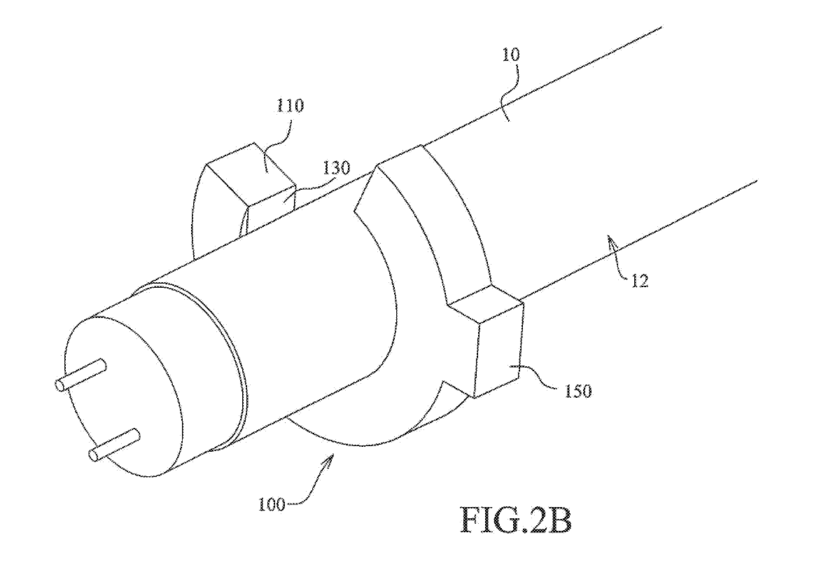

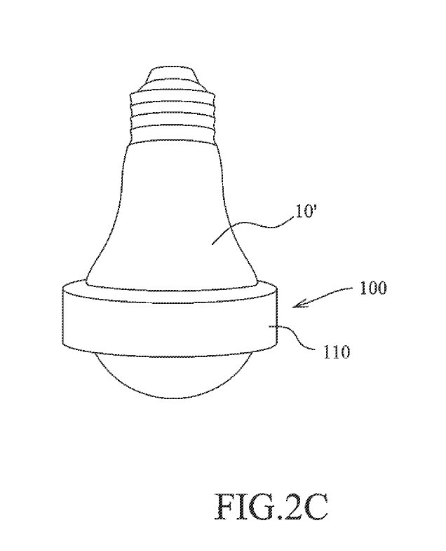

FIG. 1 is a block diagram of a circuit of a wireless beacon device with multiple power sources according to a first embodiment of the present invention. FIG. 2A is a perspective view of the wireless beacon device of the first embodiment of the present invention which is not disposed at any light source. FIG. 2B is a perspective view of the wireless beacon device of the first embodiment of the present invention which is disposed at a light source. Referring to FIG. 1, FIG. 2A, and FIG. 2B, in this embodiment, a wireless beacon device 100 comprises a housing 110, an optoelectronic unit 120, a thermoelectric unit 130, a power source selector 140, and a beacon unit 150. The optoelectronic unit 120, the thermoelectric unit 130, the power source selector 140 and the beacon unit 150 are disposed at the housing 110.

The housing 110 has a specific shape whereby the wireless beacon device 100 is disposed at a light source 10, such as a fluorescent tube (but the present invention is not limited thereto.) In this embodiment, the housing 110 can be curved and is, for example, C-shaped such that the housing 110 can be disposed at the light source 10 by means of snap fit. The optoelectronic unit 120 and the thermoelectric unit 130 are disposed at an external surface 112 of the housing 110 which is an inwardly curved surface of the C-shaped housing. The power source selector 140 and the beacon unit 150 are disposed in the housing 110. FIG. 2C is a schematic perspective view of the wireless beacon device of the first embodiment of the present invention which is disposed at another light source. Referring to FIG. 2C, a light source 10′ is a light bulb, and the housing 110 of the wireless beacon device 100 is disposed at the light source 10′ by means of snap fit. Moreover, in another embodiment, the housing is hook-shaped (not shown) and thus hooked to a light source. It should be noted that the housing of the wireless beacon device of the present invention can be disposed at the light source in any other appropriate manner. For example, the housing of the wireless beacon device can be clamped or adhered to the light source, and the housing can be designed in any shape as needed (please refer to a fourth embodiment).

Referring to FIG. 1, FIG. 2A, and FIG. 2B again, the optoelectronic unit 120 is used to receive light emitted from the operating light source 10 so as to generate a first voltage V1. That is to say, the optoelectronic unit 120 is irradiated by the operating light source 10 and thus converts optical energy into electrical energy to generate the first voltage V1. The optoelectronic unit 120 can be embodied by various types of solar cells such as monocrystalline silicon solar cells, polycrystalline silicon solar cells, and/or amorphous silicon solar cells.

The thermoelectric unit 130 is used to receive heat emitted from the operating light source 10 so as to generate a second voltage V2. The thermoelectric unit 130 can comprise at least one thermocouple for converting thermal energy into electrical energy. Considering that the light source 10 in operation usually generates much heat, it is practicable to provide a stable power source to the wireless beacon device 100 by making good use of the heat which originates from the light source 10 in operation.

When the wireless beacon device 100 is disposed at the light source 10, both the thermoelectric unit 130 and the optoelectronic unit 120 can approach a light-emitting surface 12 of the light source 10. In this embodiment, when the wireless beacon device 100 is disposed at the light source 10, the external surface 112 of the housing 110 faces and is close to the light-emitting surface 12 of the light source 10 such as a fluorescent tube, and the thermoelectric unit 130 and the optoelectronic unit 120 which are disposed at the external surface 112 of the housing 110 receive heat and light emitted from the light source 10, respectively.

The power source selector 140 has a first input end 141 and a second input end 142 which are electrically connected to the optoelectronic unit 120 and the thermoelectric unit 130, respectively and adapted for receiving the first voltage V1 and the second voltage V2, respectively. The power source selector 140 determines to output the first voltage V1 or the second voltage V2 according to a predetermined comparison relationship.

For instance, in this embodiment, the power source selector 140 compares the second voltage V2 with a voltage threshold (such as 5V, but the present invention is not limited thereto), wherein the voltage threshold is predetermined. The aforesaid predetermined comparison relationship comprises that the power source selector 140 outputs the second voltage V2 if the voltage level of the second voltage V2 is higher than the voltage threshold. In this embodiment, the aforesaid predetermined comparison relationship further comprises that the power source selector 140 outputs the first voltage V1 if the voltage level of the second voltage V2 is lower than the voltage threshold and the voltage level of the first voltage V1 is higher than the voltage threshold. In another embodiment, the power source selector 140 directly compares the voltage level of the first voltage V1 with that of the second voltage V2 and then outputs the selected voltage having the larger voltage level.

The beacon unit 150 is electrically connected to the power source selector 140 and adapted for transmitting a wireless signal by means of the second voltage V2 or the first voltage V1 output by the power source selector 140. In this embodiment, the beacon unit 150 receives the first voltage V1 or the second voltage V2 output by the power source selector 140. The beacon unit 150 can emit wireless signals by means of a Bluetooth wireless communication technology such as Bluetooth 4.0 or lower, or Bluetooth Low Energy (BLE). A power-saving wireless communication technology, such as Bluetooth, can extend the operating hours of the wireless beacon device 100, but the present invention is not limited thereto. Alternatively, the beacon unit 150 can emit wireless signals by means of Wi-Fi or any other wireless communication technology. Moreover, wireless signals transmitted from the beacon unit 150 can provide consumers with information which may interest them, for example, information pertaining to promotions and discounts offered by a shop or comments made by the other persons.

According to the above description, regarding the wireless beacon device 100 in this embodiment, the optoelectronic unit 120 and the thermoelectric unit 130 respectively generate voltages V1 and V2 by different means of energy conversion, and then the power source selector 140 selectively outputs one of the voltages V1 and V2 according to the predetermined comparison relationship to drive the beacon unit 150 to transmit wireless signals to consumers. Therefore, in this embodiment, the wireless beacon device 100 can operate for a quite long time. Moreover, since the housing 110 of the wireless beacon device 100 in this embodiment can be C-shaped, the housing 110 can be disposed conveniently at the light source 10 by means of snap fit. Furthermore, regarding the wireless beacon device 100 in this embodiment, the optoelectronic unit 120 and the thermoelectric unit 130 can be disposed at the external surface 112 (which is used to face and approach the light-emitting surface 12 of the light source 10) of the housing 110, and thus the thermoelectric unit 130 and the optoelectronic unit 120 which are disposed at the external surface 112 of the housing 110 can make good use of heat and light generated by the operating light source 10 and generate power required for operation of the wireless beacon device 100.

### Second Embodiment

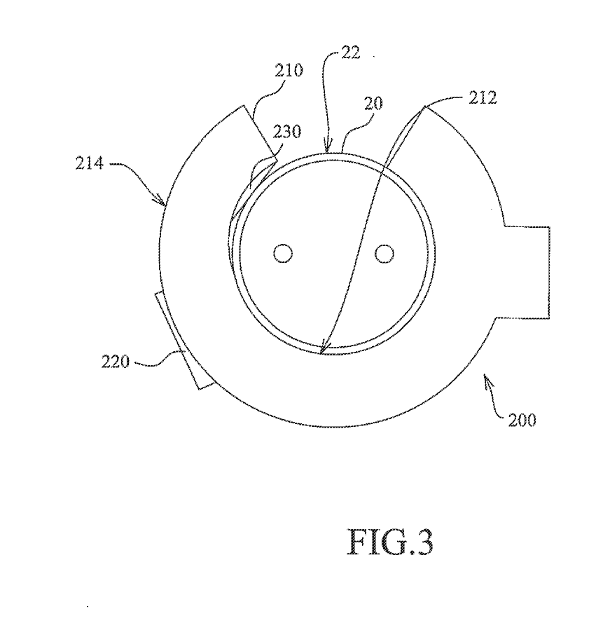

FIG. 3 is a schematic end view of a light source where a wireless beacon device according to a second embodiment of the present invention is disposed. As shown in FIG. 3, in this embodiment, an optoelectronic unit 220 and a thermoelectric unit 230 of a wireless beacon device 200 are respectively disposed at two opposite surfaces 214 and 212 of a housing 210 which can be C-shaped. Specifically speaking, the thermoelectric unit 230 is disposed at the external surface 212 of the housing 210 which is the inwardly curved surface of the C-shaped housing. The optoelectronic unit 220 is disposed at another external surface 214 of the housing 210 which is the outwardly curved surface of the C-shaped housing. The external surface 214 is opposite to the external surface 212. When the wireless beacon device 200 is disposed at a light source 20, the external surface 212 of the housing 210 faces and is close to a light-emitting surface 22 of the light source 20 such as a fluorescent tube and the external surface 214 faces outwardly. Hence, the optoelectronic unit 220 is used to be illuminated by an illuminant (such as another light source or sunlight) other than the light source 20.

### Third Embodiment

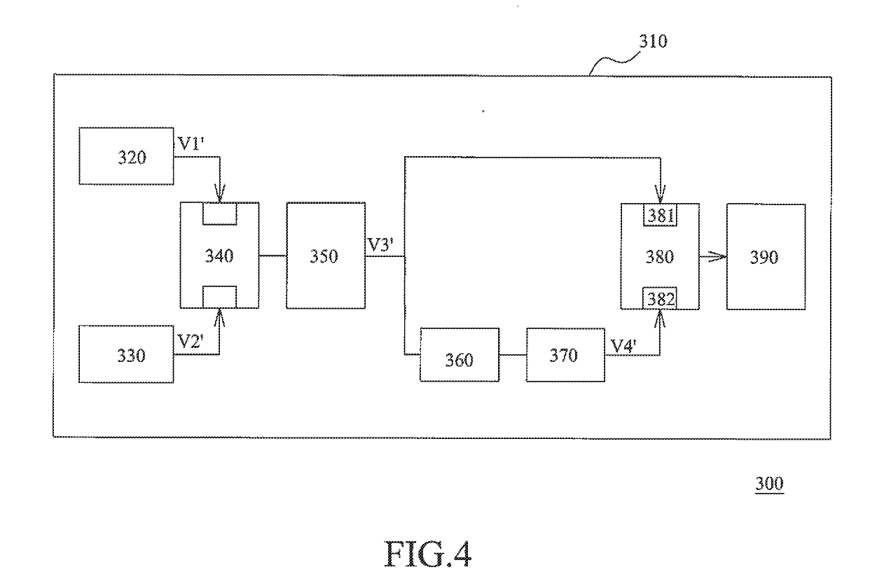

FIG. 4 is a block diagram of the circuit of a wireless beacon device with multiple power sources according to a third embodiment of the present invention. As shown in FIG. 4, in addition to a housing 310, an optoelectronic unit 320, a thermoelectric unit 330, a power source selector 340 and a beacon unit 390, a wireless beacon device 300 further comprises a voltage regulator 350, a battery charge controller 360, a rechargeable battery 370, and another power source selector 380. The details of the housing 310, the optoelectronic unit 320, the thermoelectric unit 330 and the power source selector 340 of the wireless beacon device 300 in this embodiment can be referred to the related description regarding the housing 110, the optoelectronic unit 120, the thermoelectric unit 130 and the power source selector 140 of the wireless beacon device 100 in the first embodiment and therefore, is not described here. In addition, the configuration of the housing 310, the optoelectronic unit 320 and the thermoelectric unit 330 of the wireless beacon device 300 in this embodiment can be referred to the configuration of the housing 210, the optoelectronic unit 220 and the thermoelectric unit 230 in the second embodiment and therefore, is not described here.

The power source selector 340, voltage regulator 350, battery charge controller 360, rechargeable battery 370, power source selector 380 and the beacon unit 390 are disposed in the housing 310. The voltage regulator 350 is electrically connected to the power source selector 340 and used to adjust the voltage output by the power source selector 340 (i.e., a first voltage V1′ or a second voltage V2′ after the selection of the power source selector 340) to a specific voltage. In this embodiment, to preclude any negative effect of the instability of the first voltage V1′ generated by the optoelectronic unit 320 or the second voltage V2′ generated by the thermoelectric unit 330 on subsequent circuit units, the voltage regulator 350 is provided to steadily output the specific voltage, that is, an working voltage V3′ used for driving the beacon unit 390 (described later).

The power source selector 380 has a first input end 381 and a second input end 382. The first input end 381 is electrically connected to the voltage regulator 350 to receive the working voltage V3′. The second input end 382 is electrically connected to the rechargeable battery 370 to receive a battery voltage V4′. The power source selector 380 determines to output the working voltage V3′ or the battery voltage V4′ according to another predetermined comparison relationship.

For instance, in this embodiment, the power source selector 380 compares the working voltage V3′ with a voltage threshold (such as 5V, but the present invention is not limited thereto), wherein the voltage threshold is predetermined. The other predetermined comparison relationship comprises that the power source selector 380 outputs the working voltage V3′ if the voltage level of the working voltage V3′ is higher than the voltage threshold. In this embodiment, the aforesaid other predetermined comparison relationship further comprises that the power source selector 380 outputs the battery voltage V4′ if the voltage level of the working voltage V3′ is lower than the voltage threshold and the voltage level of the battery voltage V4′ of the rechargeable battery 370 is higher than the voltage threshold. In another embodiment, the power source selector 380 directly compares the voltage level of the working voltage V3′ with that of the battery voltage V4′ and then outputs the selected voltage having the larger voltage level.

The battery charge controller 360 is electrically connected to the voltage regulator 350 and the rechargeable battery 370. The battery charge controller 360 detects the battery voltage V4′ to determine whether to charge the rechargeable battery 370 with the working voltage V3′. For example, as the battery charge controller 360 detects that the voltage level of the battery voltage V4′ is lower than a specific voltage level, it begins charging the rechargeable battery 370 with the working voltage V3′. Moreover, to prevent the rechargeable battery 370 from being overcharged and thus ending up with a short service life, the battery charge controller 360 can stop charging the rechargeable battery 370 as it detects that the voltage level of the battery voltage V4′ is higher than another specific voltage level.

The rechargeable battery 370 is a battery capable of storing electrical energy and being repeatedly recharged. In this embodiment, the rechargeable battery 370 can supply the battery voltage V4′ to the beacon unit 390 when the optoelectronic unit 320 and the thermoelectric unit 330 fail to generate the first voltage V1′ and the second voltage V2′ as required. For example, if the staff in an indoor shop turns off an indoor light source during lunch breaks, the optoelectronic unit 320 will not be illuminated by the light source and sunlight and thus cannot generate the first voltage Vt. Moreover, due to the indoor light source being turned off, the thermoelectric unit 330 cannot receive from the light source any heat required to generate the second voltage V2′. At this time, the battery voltage V4′ of the rechargeable battery 370 is suitable to drive the beacon unit 390 to keep transmitting signals.

In conclusion, the beacon unit 390 electrically connected to the power source selector 380 is adapted for receiving the battery voltage V4′ or the working voltage V3′ output by the power source selector 380 so as to transmit wireless signals. On the whole, the beacon unit 390 is adapted for transmitting wireless signals by means of the first voltage V1′ or the second voltage V2′ output by the power source selector 340 or by means of the battery voltage V4′ generated from the rechargeable battery 370.

### Fourth Embodiment

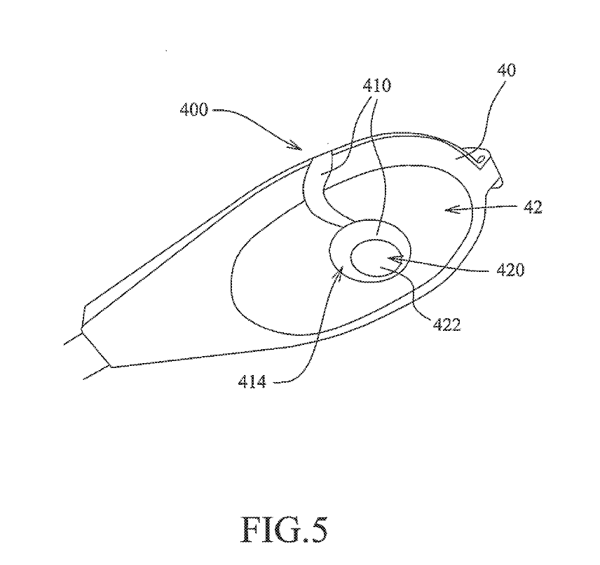

FIG. 5 is a schematic perspective view of a wireless beacon device according to a fourth embodiment of the present invention which is disposed at a light source. As shown in FIG. 5, a housing 410 of a wireless beacon device 400 in this embodiment clamps a light source 40 which is, for example, an outdoor street lamp. Moreover, an optoelectronic unit 420 of the wireless beacon device 400 comprises a first optoelectronic portion 422 and a second optoelectronic portion (not shown in FIG. 5). The first optoelectronic portion 422 is disposed at an external surface 414 of the housing 410 and the second optoelectronic portion is disposed at another external surface (not shown in FIG. 5) of the housing 410 opposite to the external surface 414. When the wireless beacon device 400 clamps the light source 40, a thermoelectric unit (not shown in FIG. 5) and the second optoelectronic portion disposed at the other external surface approach a light-emitting surface 42 of the light source 40 and receive the heat and the light generated by the operating light source 40 and the first optoelectronic portion 422 disposed at the external surface 414 is used be illuminated by an illuminant (such as another light source or sunlight) other than the light source 40.

The wireless beacon device of an embodiment of the present invention has one of the following advantages or another advantage. Regarding the wireless beacon device in an embodiment of the present invention, the optoelectronic unit and the thermoelectric unit respectively generate voltages by different means of energy conversion, and then the power source selector selectively outputs one of the voltages according to the predetermined comparison relationship to drive the beacon unit to transmit wireless signals to consumers. Therefore, in this embodiment of the present invention, the wireless beacon device can operate for a quite long time. Moreover, since the housing of the wireless beacon device in an embodiment of the present invention can be C-shaped, the housing can be disposed conveniently at a light source by means of snap fit. Furthermore, regarding the wireless beacon device in an embodiment of the present invention, the thermoelectric unit and at least part of the optoelectronic unit can be disposed at the external surface of the housing at least part of which is used to face and approach a light-emitting surface of a light source, and thus the thermoelectric unit and the at least part of the optoelectronic unit which are disposed at this external surface of the housing can make good use of heat and light generated by the operating light source and generate power required for operation of the wireless beacon device.

The foregoing detailed description of the embodiments is used to further clearly describe the features and spirit of the present invention. The foregoing description for each embodiment is not intended to limit the scope of the present invention. All kinds of modifications made to the foregoing embodiments and equivalent arrangements should fall within the protected scope of the present invention. Hence, the scope of the present invention should be explained most widely according to the claims described thereafter in connection with the detailed description, and should cover all the possibly equivalent variations and equivalent arrangements.

What is claimed is:

1. A wireless beacon device, comprising:
an optoelectronic unit adapted for generating a first voltage;
a thermoelectric unit adapted for generating a second voltage;
a first power source selector having a first input end and a second input end adapted for receiving the first voltage and the second voltage, respectively, wherein the first power source selector is adapted for outputting the first voltage or the second voltage according to a first predetermined comparison relationship; and
a beacon unit electrically connected to the first power source selector and adapted for transmitting a wireless signal by means of the first voltage or the second voltage output by the first power source selector.

2. The wireless beacon device of claim 1, wherein the first predetermined comparison relationship comprises that the first power source selector outputs the second voltage if a voltage level of the second voltage is higher than a voltage threshold.

3. The wireless beacon device of claim 2, wherein the first predetermined comparison relationship further comprises that the first power source selector outputs the first voltage if the voltage level of the second voltage is lower than the voltage threshold and a voltage level of the first voltage is higher than the voltage threshold.

4. The wireless beacon device of claim 1, further comprising a housing, wherein the optoelectronic unit, the thermoelectric unit, the first power source selector and the beacon unit are disposed at the housing.

5. The wireless beacon device of claim 4, wherein the housing is curved.

6. The wireless beacon device of claim 5, wherein the optoelectronic unit and the thermoelectric unit are disposed at an external surface of the housing, and when the wireless beacon device is disposed at a light source, the external surface faces a light-emitting surface of the light source.

7. The wireless beacon device of claim 5, wherein the thermoelectric unit is disposed at a first external surface of the housing, the optoelectronic unit is disposed at a second external surface of the housing, the second external surface is opposite to the first external surface, and when the wireless beacon device is disposed at a light source, the first external surface faces a light-emitting surface of the light source.

8. The wireless beacon device of claim 5, wherein the thermoelectric unit and a portion of the optoelectronic unit are disposed at a first external surface of the housing, another portion of the optoelectronic unit is disposed at a second external surface of the housing, the second external surface is opposite to the first external surface, and when the wireless beacon device is disposed at a light source, the first external surface faces a light-emitting surface of the light source.

9. The wireless beacon device of claim 5, wherein the housing is C-shaped.

10. The wireless beacon device of claim 1, further comprising:
a voltage regulator electrically connected to the first power source selector and adapted for adjusting the first voltage or the second voltage output by the first power source selector so as to output a working voltage;
a battery charge controller electrically connected to the voltage regulator and adapted for receiving the working voltage;
a rechargeable battery electrically connected to the battery charge controller, wherein the battery charge controller is adapted for detecting a battery voltage of the rechargeable battery so as to determine whether to charge the rechargeable battery with the working voltage; and
a second power source selector having a first input end and a second input end adapted for receiving the working voltage and the battery voltage, respectively, wherein the second power source selector is adapted for outputting the working voltage or the battery voltage according to a second predetermined comparison relationship, and the beacon unit is electrically connected to the second power source selector and adapted for receiving the working voltage or the battery voltage output by the second power source selector so as to transmit the wireless signal.

11. The wireless beacon device of claim 10, wherein the second predetermined comparison relationship comprises that the second power source selector outputs the working voltage if a voltage level of the working voltage is higher than a voltage threshold.

12. The wireless beacon device of claim 11, wherein the second predetermined comparison relationship further comprises that the second power source selector outputs the battery voltage if the voltage level of the working voltage is lower than the voltage threshold and a voltage level of the battery voltage is higher than the voltage threshold.
